(19) United States
(12) Patent Application Publication
(10) Pub. No.: US 2006/0271262 A1
(43) Pub. Date: Nov. 30, 2006

(54) Wireless agricultural network

(76) Inventor: Harry Phillip McLain III, Statesville, NC (US)

Correspondence Address: Keith J. Swedo, Suite 3500, One Indiana Square, Indianapolis, IN, 46204, US

(21) Appl. No.: 11/439,849

(22) Filed: May 24, 2006

Related U.S. Application Data
(60) Provisional application No. 60/684,029, filed on May 24, 2005.

(51) Int. Cl. G06F 19/00

(52) U.S. Cl. 701/50

(57) ABSTRACT

A farm vehicle monitoring system includes a plurality of farm vehicles and a plurality of sensing devices. Each of the sensing devices measures a respective operating parameter of a respective farm vehicle. A processor collects measurement data from the sensing devices and outputs a report based upon the measurement data. The report is in user readable form.

### CROSS-REFERENCE TO RELATED APPLICATIONS

Priority of my U.S. Provisional Patent Application Ser. No. 60/684,029, titled HARVESTING MONITORING SYSTEM INCLUDING RUGGEDIZED CAMERA FOR USE ON HEAVY EQUIPMENT, filed 24 May 2005, incorporated herein by reference, is hereby claimed.

### BACKGROUND OF THE INVENTION

1. Field of the Invention.

The present invention relates to a system for monitoring the operation of farm vehicles, and more particularly, to a system for simultaneously monitoring the operation of a plurality of farm vehicles.

2. Description of the Related Art.

In farming, harvesting vehicles are used to cut or harvest the crop and deposit the harvested crop in an adjacent transporting vehicle. The harvested crop may be propelled through a chute from the harvesting vehicle to the transporting vehicle. A problem in the farming industry is that it is difficult to monitor the productivity or yields of all the operations that may be occurring, as well as determine the productivity of a single operation with respect to how much agricultural product is going on or out of a transporting vehicle, the moisture content of the product, the amount harvested/planted/sprayed per acre, and the total amount harvested/planted/sprayed per vehicle, per field, per silo, per unit time (e.g., per hour, per day, per week, per month, or per entire season). Another problem is that other functions may be going on simultaneously within a farm business that a manager would appreciate analyzing and controlling from a central location, be it an office or another piece of equipment on the network.

What is needed in the art is a system that enables an individual, and particularly the driver of a harvesting/planting/spraying vehicle, to visually monitor the depositing of the harvested crop into or out of the transporting vehicle, and to monitor the productivity or yield statistics of the harvested/planted/sprayed crop, for not only the harvesting/planting/spraying vehicle he is driving, but also of all harvesting/planting/spraying and other functioning vehicles of a farming operation that are networked together in the system.

### SUMMARY OF THE INVENTION

The present invention provides a ruggedized heavy equipment camera system for monitoring the flow of agricultural product from the working machine to the transporting machine. The camera system may be combined with a comprehensive management system for the calculation of yield and a comprehensive management networking system that allows for the combination of total data or for monitoring productivity between other operations.

A harvesting monitoring system includes a ruggedized camera for use on heavy equipment that enables the operator of harvesting equipment to visually monitor on a display screen the crop that is being deposited into a truck. The camera and display screen are only phase 1 of a 3-phase invention. Phase 2 involves a CMS (Comprehensive Management System) that incorporates the camera visibility with a yield calculation program that may run on a tablet personal computer (pc) or a computer that is compatible with a controller area network (CAN) bus, thus eliminating any need for a standard flat screen television monitor, or any other type of dedicated monitor. This allows the operator of the working machine to see where the crop load is being deposited in the transporting vehicle and provides the operator with statistics regarding how much crop is going on a truck, the moisture content of the crop, the amount harvested per acre and the total amount harvested per truck, per field, per silo, per hour, per day, per week, per month, or per entire season.

Using a tablet pc or can allows not only facilitation of software, but also provides the standard computing applications such as wireless internet capabilities. When the tablet pc is powered on, a menu may appear on the desktop of the Microsoft tablet edition. By tapping the menu button on the screen, a program can be entered. The program may start up and default to the camera/yield screen, thus powering up an outside wireless camera and yield monitoring components. Phase 3 involves a CMNS (Comprehensive Management Networking System) which includes a wireless network between machines that have tablet pcs in order to combine total data or to monitor productivity of other operations that a farm manager may have in progress.

The combination of all three phases of the invention allows monitoring the flow of agricultural product from the working machine to the transporting machine; determining how much product is going on a transportation machine, the moisture content of the product, the amount harvested per acre, and the total amount harvested per truck, per field, per silo, per hour, per day, per week, per month, or per entire season; and combining total data between a plurality of working machines or monitoring productivity of other operations that a farm manager may have in progress.

The invention provides a comprehensive management networking system including machines and their systems of real time data collection, real time data production, camera monitoring, and remote assisting and/or programming. Any of the functions of the invention may be performed remotely. The system may include base computers, laptops, wireless PDAs, and wireless phones operating remotely from machines and their systems.

By forming a network between machines and computers, the real time data produced by multiple machines may be combined. Thus, machines may be viewed, monitored and controlled remotely by another machine, a laptop PC, desktop PC, wireless PDA, or wireless phone based on data received or not received from the machines and their systems.

Possible functions to be combined, analyzed, or remotely assisted/programmed may include:
Camera viewing where agricultural product is being deposited relative to a targeted container (truck, wagon, cart, etc.).
Camera viewing/monitoring of any mechanical functions or malfunctions of the machine that may or may not be viewable to the operator while the machine is in operation.
Camera viewing/monitoring of how agricultural product flows through systems of mechanical functions in a machine that may or may not be viewable to the operator while the machine is in operation.
Camera viewing of where agricultural product is being deposited in the ground for planting.
Camera viewing of any agricultural product or supplement that is to be viewed as it is deposited on the ground along a designated or nondesignated path or nonpath.
Camera angle and pitch adjustment.
Microphone volume adjustment such that the operator may hear possible malfunctions of the machine being monitored.
Data calibration and adjustment of any machines and their systems.
Mechanical adjustment and calibration of any machines and their systems.
Path interruption and/or adjustment relative to a path created by the operator, a computer, or a global positioning system.
Data that is collected in relation to farming functions may include:

The amount or weight of any product that is being, or that has been, deposited in a container, on the ground, or in the ground.
The amount or weight of any product that remains left to use in a container.
The moisture content of harvested crops.
The harvested yield per acre.
The amount planted per acre.
The amount of product deposited per acre over the ground or in the ground.

Data that is collected in relation to machines may include:
The temperatures of mechanical functions.
The speeds of mechanical functions.

Data that is produced may include:
The amount of crop that is harvested per acre.
The total amount of product that is collected or dispersed per machine, per truck, per field, and/or per unit time.

With current technology, yield maps may be created by collecting the machine's computer cards, loading the cards into a computer, and then combining the data to create the map. The present invention enables a yield map to be created in real time as multiple machines simultaneously harvest a field.

The invention comprises, in one form thereof, a farm vehicle monitoring system including a plurality of farm vehicles and a plurality of sensing devices. Each of the sensing devices measures a respective operating parameter of a respective farm vehicle. A processor collects measurement data from the sensing devices and outputs a report based upon the measurement data. The report is in user readable form.

The invention comprises, in another form thereof, a method of monitoring farm vehicles including providing a plurality of sensing devices on the farm vehicles. Respective operating parameters of the respective farm vehicles are measured by use of the sensing devices. Measurement data is transmitted from the sensing devices to a central processor. A report based upon the measurement data transmitted to the processor is output in user readable form.

The invention comprises, in yet another form thereof, a farm harvest vehicle monitoring system including a plurality of farm harvest vehicles. Each of a plurality of crop sensing devices is associated with a respective one of the farm vehicles and measures harvest data. A processor is in wireless electronic communication with the sensing devices and collects harvest data from the sensing devices in real time. A report based upon the harvest data is output in user readable form.

An advantage of the invention is that a single screen may be used to show the operator of a harvesting vehicle both the crop being deposited into the transportation vehicle and yield statistics for the harvested crop. Thus, the human operator may ensure that the crop is not spilling onto the ground and may determine the quality and quantity of the harvested crop.

Another advantage is that any number of harvesting vehicles may be networked together. Thus, a manager may monitor the yields and operation of harvesting vehicles other than the harvesting vehicle that he is personally operating. The manager may monitor from a central office with an office computer, laptop, PDA, or wireless phone. Networking also enables the yield information from all of the harvesting vehicles to be automatically combined in real time. Thus, it is possible to determine more exactly and in real time the combined tonnage of the entire crop harvested from any number of harvesting vehicles.

Yet another advantage is that the present invention may be applied to other types of farm vehicles, such as sprayers, fertilizer spreaders, seed feeders, and combines, for example. These farm vehicles may be equipped with global positioning system (GPS) devices in order to determine which sections of the fields have been covered by the vehicles, and to ensure that each section is covered once and only once. The amount of spray medium, fertilizer and/or seeds deposited in each field section may be determined in real time.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein

FIG. 1 is a block diagram of one embodiment of a farm vehicle monitoring system of the present invention.

FIG. 2 is a perspective view of one embodiment of a farm vehicle, camera, and associated transporting vehicle associated with the farm vehicle monitoring system of FIG. 1.

FIG. 3 is a perspective view of a tablet pc that may be used in the farm vehicle monitoring system of FIG. 1.

FIG. 4 is one embodiment of a screen configuration that may be displayed on the displays of FIG. 1 or on the tablet pc of FIG. 3.

FIG. 5 is a perspective view of one embodiment of a camera and mounting apparatus that may be used to affix the camera to the crop chute between a harvesting vehicle and a transport truck.

FIG. 6 is a bottom view of the mounting bracket of FIG. 5.

FIG. 7 is top view of the camera and mounting bracket of FIG. 5.

FIG. 8 is a more detailed perspective view of the camera box of the mounting apparatus of FIG. 5 that may be used in a farm vehicle monitoring system of the present invention.

Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

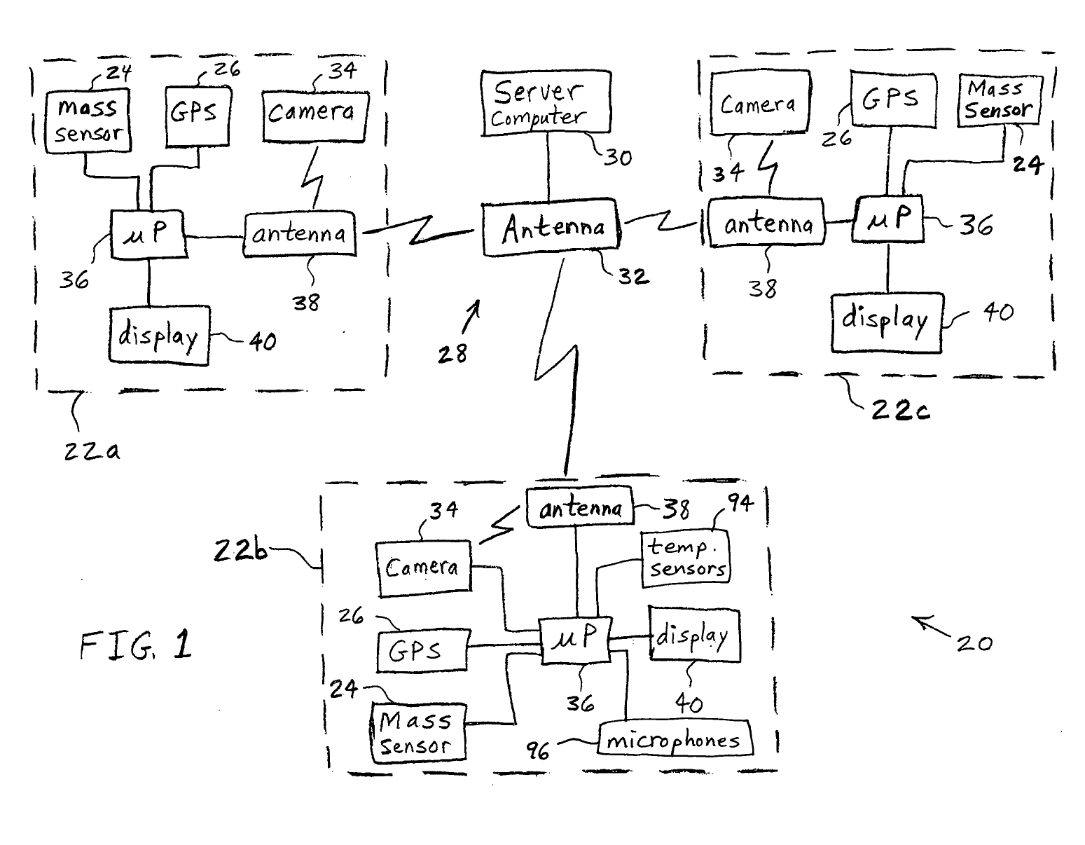

Referring now to the drawings, and particularly to FIG. 1, there is shown one embodiment of a farm vehicle monitoring system 20 of the present invention. System 20 includes farm vehicles 22a, 22b, 22c in communication with a central processor 28 in the form of a server computer 30 in communication with an antenna 32. Vehicles 22 may be crop harvesting vehicles, for example. Each vehicle may include a mass sensor 24, a global positioning satellite (GPS) device 26, a camera 34, a microprocessor 36, an antenna 38, and a display 40.

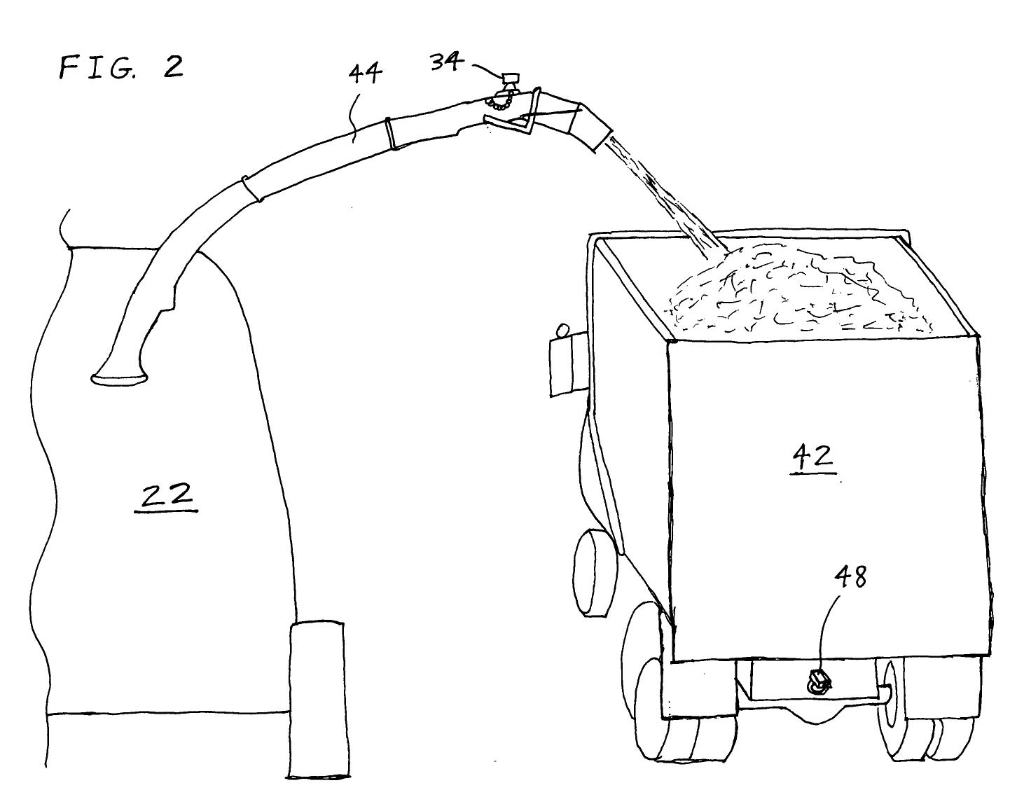

Mass sensor 24 may be in the form of a crop sensing device that derives the mass of crop harvested by a vehicle 22 based upon the measured or known force and measured or known acceleration of the crop as it is deposited in a transport vehicle 42 (FIG. 2). The crop mass may be derived from the well known equation: Force=mass x acceleration. The force may be measured with a pressure plate sensor against which the harvested crop impinges out of chute 44. A pulley-based sensor may measure acceleration. Alternatively, sensor 24 may be in the form of any conventional weight scale. As shown in FIG. 2, the crop may be directed from harvesting vehicle 22 to the bed of transport vehicle 42 through a chute 44.

Camera 34 may be positioned on and affixed to chute 44 such that camera 34 captures an image 46 (FIG. 4) of the crop being deposited in transport vehicle 42. The image captured by camera 34 may be displayed on a display in the form of a computer monitor 40 (FIG. 1) that is situated in the passenger compartment of vehicle 22 such that a driver of vehicle 22 may see the display. The outputs of sensor 24 and GPS 26 may be displayed on display 40 in the form of text messages, perhaps simultaneously with the images captured by camera 34.

Microprocessor 36 may calculate the crop yield of the associated vehicle 22 based upon the mass measurements of mass sensor 24, by unit time or area of field harvested, for example. This yield information may be displayed on display 40.

The data, images and yield calculations output by sensor 24, GPS 26, camera 34 and microprocessor 36 may be wirelessly transmitted via antennas 38, 32 to servo computer 30. Computer 30 may compile the data and yield calculations from each of vehicles 22 and produce further calculations related to the overall productivity, crop yields, or total weight of harvested crop of all of vehicles 22 as a group. Thus, computer 30 may output a report based on the measurement data from the sensors. Via antenna 32, computer 30 may transmit the overall productivity, crop yield, or total harvest weight calculations to any or all of vehicles 22 for display of the report in user readable form on the respective display 40. Moreover, it is possible for the images captured on one of cameras 34 to be transmitted to another vehicle or a central office, perhaps via central processor 28, such that a driver in the other vehicle or a farm manager can visually monitor the visual images, the sounds and the data from another vehicle, and then make adjustments to the equipment of the other vehicle based upon the feedback received. In one example, the driver of the other vehicle or the farm manager may monitor the crop being deposited in the transport vehicle by the harvesting vehicle associated with camera 34. It is possible for images captured by cameras 34 to be wirelessly transmitted directly to antenna 32 as well as to antennas 38.

Other types of sensors on vehicles 22 may be added to system 20 and connected to the microprocessors. For example, vehicle 22b in FIG. 1 includes temperature sensors 94 and microphones 96. Each of sensors 94 and microphones 96 may be strategically placed in vehicle 22b to thereby collect temperature measurement data and sound measurement data of interest. Such temperature data and sound data may be analyzed by microprocessor 36, server 30, and/or by the human operator to diagnose machine malfunctions, or to monitor the operations of the machines, for example. The sound measurement data may be reproduced as sound, i.e., audibly broadcast, on a speaker or headphones for the vehicle driver or a farm manager to selectively listen to, for example.

One of vehicles 22 may be designated a master vehicle such that the master vehicle receives yield data for each of the other vehicles, both individually and in the aggregate, i.e., as a group. The master vehicle may also have the option of selectively viewing images captured by the camera of any other vehicle as well as by the camera of the master vehicle.

As shown in FIG. 2, a camera 48 may be provided on a rear end of transport vehicle 42 in order to capture an image of the portion of the roadway behind vehicle 42. The image may be selectively displayed on display 40 so that the driver of vehicle 22 may determine whether harvested crop is falling out of the bed of transport vehicle 42 and onto the roadway.

A wireless kit may be used in conjunction with the present invention. The kit may include a wireless camera 34 that may operate at 2.4 GHz, for example, and that may be powered by either an AC adapter or a 9 V battery, for example.

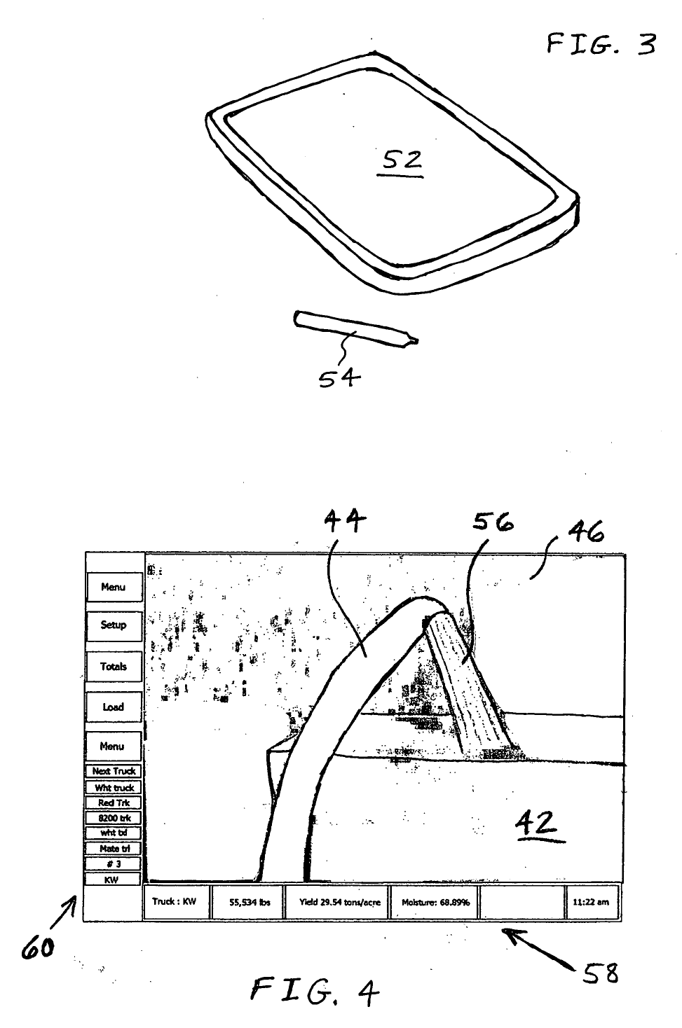

In another embodiment, microprocessor 36 and display 40 are in the form of a tablet pc 52 (FIG. 3) including a pen 54. A model tc1100 tablet pc available from HP Compaq Corporation may be suitable.

FIG. 4 illustrates one embodiment of a default page screen that may be displayed on display 40. The majority of the screen shows image 46 captured by camera 34, namely harvested crop 56 being deposited into the bed of vehicle 42 via chute 44. Yield information 58 is displayed at the bottom of the screen. Selectable icons 60 enable the user to modify which image 46 from which of cameras 34 is displayed on the screen, and what types of productivity data is displayed at the bottom of the screen.

A forage harvester type of vehicle 22 may harvest crops and deposit the crops into a transport vehicle 42 via a chute 44. In another embodiment, the transport vehicle follows behind the farm vehicle. Other applications of the farm vehicle monitoring system of the present invention include a sprayer, a combine, and a planter/seeder. In the case of a farm vehicle that deposits product on the fields, such as fertilizer, seeds, insecticide, herbicide, etc., the data-gathering sensor may detect the mass of the product that is being deposited on the field, or may detect some other operating parameter of the farm vehicle. The microprocessor may then monitor the amount of product being deposited per unit time. By use of GPS or another position sensing device, the microprocessor may also monitor the amount of product being deposited per unit field area or per field. By the central processor collecting measurement data from the sensing devices, and by networking the various farm vehicles together, it is possible to track which fields or sections of fields have had product deposited thereon, and prevent each section of field from having product deposited twice or not at all. Moreover, because different sections of a field may require different numbers/weights of seeds or other product per unit area, the network of the present invention may enable the actual amount of product being deposited by all the farm vehicles to be monitored in real time. Thus, the network may enable product feed rates to be modified in real time, i.e., “on-the-fly”, such that all of the farm vehicles combined may deposit a predetermined or available amount of the product on all of the fields in one operation.

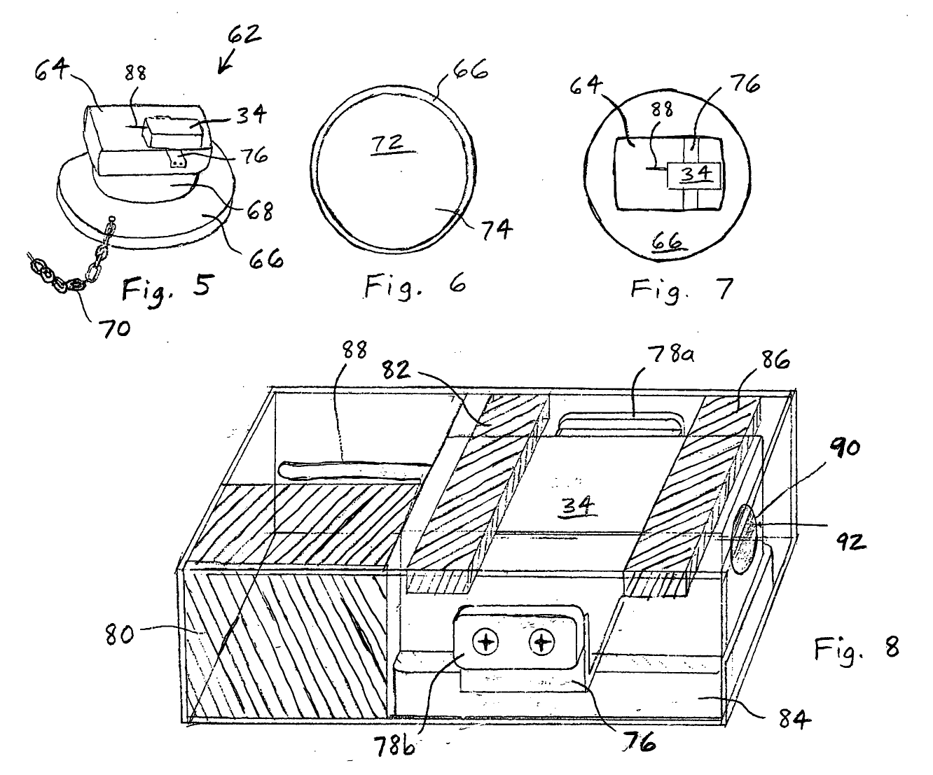

FIGS. 5-8 illustrate one embodiment of a mounting apparatus 62 for mounting camera 34 on chute 44. Apparatus 62 includes a camera box 64 fixedly mounted on a circular magnetic base 66 via a neck portion 68. Base 66 may be chained to chute 44 via a chain 70. Base 66 may include a circular magnet 72 having a flat bottom surface 74. Camera 34 may be attached to box 64 via a metal mount 76. Mount 76 may be secured to box 64 via rubber absorbers 78a, 78b. Cushions 80, 82, 84, 86 may be provided to prevent camera 34 from moving within box 64 and to dampen any vibration to which camera 34 may be subjected. Camera 34 includes an antenna 88 for transmitting captured images to antenna 38 and/or antenna 32. Box 64 may include a watertight Plexiglas casing having an opening 90 for exposing lens 92 of camera 34.

Unlimited numbers of machines and users (computers, PDAs, wireless phones, etc.) may be added and given certain authentication, password, and/or permission rights. Administrative properties may be switched to any machine given password permission rights.

A long distance receiver may be used to pick up signals at a great distance, such as thirty miles. Technology marketed under the names “Y Max” and/or BLUETOOTH may be suitable. Alternatively, GPS-to-GPS receivers may be used.

The cameras have been described herein as showing product being deposited in containers or on the ground. However, the cameras may also be positioned so as to show locations and mechanisms of interest in the vehicle itself. Such cameras may be used by the vehicle driver or by a fleet manager to diagnose mechanical problems, such as a rock getting stuck in the mechanism, or a conduit becoming blocked up with packed crop or product, for example.

While this invention has been described as having an exemplary design, the present invention may be further modified within the spirit and scope of this disclosure. This application is therefore intended to cover any variations, uses, or adaptations of the invention using its general principles.

What is claimed is:

1. A farm vehicle monitoring system, comprising:
a plurality of farm vehicles;
a plurality of sensing devices, each of said sensing devices being associated with a respective one of said farm vehicles and being configured to measure a respective operating parameter of said respective farm vehicle; and
a processor in electronic communication with said sensing devices and configured to:
collect measurement data from said sensing devices; and
output a report based upon the measurement data, the report being in user readable form.

2. The system of claim I further comprising a display monitor in electronic communication with said processor and configured to display the report.

3. The system of claim 2 wherein said display monitor is disposed in one of said farm vehicles.

4. The system of claim 1 wherein said farm vehicles comprise harvest vehicles, said sensing devices comprising mass sensors configured to measure a weight of crop harvested by said harvest vehicles.

5. The system of claim 1 further comprising:
a plurality of cameras, each of said cameras being associated with a respective one of said farm vehicles and being configured to capture an image associated with said respective farm vehicle; and
a plurality of display monitors, each of said display monitors being associated with a respective one of said farm vehicles and being configured to display the image captured by a respective one of said cameras.

6. The system of claim 5 wherein each said display monitor is in electronic communication with said processor and is configured to display the report.

7. The system of claim 1 wherein said sensing devices comprise mass sensors.

8. The system of claim 1 further comprising a plurality of global positioning satellite devices, each said global positioning satellite device being associated with a respective one of said farm vehicles and being configured to transmit position information to said processor.

9. The system of claim 1 wherein the measurement data comprises crop yield data.

10. The system of claim 1 wherein the measurement data is transmitted wirelessly to said processor.

11. A method of monitoring farm vehicles, comprising the steps of:
providing a plurality of sensing devices on said farm vehicles;
measuring respective operating parameters of said respective farm vehicles by use of said sensing devices;
transmitting measurement data to a central processor; and
outputting a report based upon the measurement data transmitted to said processor, the report being in user readable form.

12. The method of claim 1 1, comprising the further step of displaying the report on a display monitor.

13. The method of claim 11 comprising the further steps of:
providing a plurality of cameras, each of said cameras being associated with a respective one of said farm vehicles;
capturing images associated with said farm vehicles by use of said cameras;
providing a plurality of display monitors, each of said display monitors being associated with a respective one of said farm vehicles; and
displaying the images captured by said cameras on said display monitors.

14. The method of claim 13 wherein the displaying step includes displaying images captured by a first said camera associated with a first of said farm vehicles on a selected said display monitor associated with a second of said farm vehicles.

15. The method of claim 11 further comprising the steps of:
providing a plurality of global positioning satellite devices, each of said global positioning satellite devices being associated with a respective one of said farm vehicles; and
transmitting position information from said global positioning satellite devices to said processor.

16. A farm harvest vehicle monitoring system, comprising:
a plurality of farm harvest vehicles;
a plurality of crop sensing devices, each of said sensing devices being associated with a respective one of said farm vehicles and being configured to measure harvest data; and
a processor in wireless electronic communication with said sensing devices and configured to:
collect harvest data from said sensing devices in real time; and
output a report based upon the harvest data, the report being in user readable form.

17. The system of claim 16 further comprising a display monitor in electronic communication with said processor and configured to display the report.

18. The system of claim 16 wherein said sensing devices comprise mass sensors configured to measure a weight of crop harvested by said harvest vehicles.

19. The system of claim 16 further comprising:
a plurality of cameras, each of said cameras being associated with a respective one of said farm vehicles and being configured to capture an image associated with said respective farm vehicle; and
a plurality of display monitors, each of said display monitors being associated with a respective one of said farm vehicles and being configured to display the image captured by a respective one of said cameras.

20. The system of claim 19 wherein each said display monitor is in electronic communication with said processor and is configured to display the report simultaneously with the images captured by the cameras.
